(19) United States
(12) Patent Application Publication
(10) Pub. No.: US 2023/0272168 A1
(43) Pub. Date: Aug. 31, 2023

(54) POLYDIORGANOSILOXANE PREPARATION

(71) Applicant: DOW SILICONES CORPORATION, Midland, MI (US)

(72) Inventors: Aaron SEITZ, Midland, MI (US); Michael H. WANG, Midland, MI (US); Phil WILSON, Elizabethtown, KY (US)

(21) Appl. No.: 18/023,713

(22) PCT Filed: Jun. 28, 2021
(86) PCT No.: PCT/US2021/039299

§ 371 Date: Feb. 27, 2023

Related U.S. Application Data
(60) Provisional application No. 63/072,257, filed on Aug. 31, 2020.

(51) Int. Cl. C08G 77/38; C08G 77/08; C08G 77/16; C08K 5/5419

(52) U.S. Cl. CPC C08G 77/38; C08G 77/08; C08G 77/16; C08K 5/5419; C08G 2190/00

(57) ABSTRACT

A process for end-capping a dimethylsilanol terminated polydiorganosiloxane with one or more di, tri and/or tetra alkoxysilanes in the presence of an end-capping catalyst starting material is provided. The end-capping catalyst starting material comprises one or more linear, branched or cyclic molecules comprising at least one amidine group, guanidine group, or derivatives of the amidine group and/or guanidine group or a mixture thereof. The resulting capped polymeric material may be utilized as a polymer in, e.g., a polydiorganosiloxane elastomer composition.

This relates to a process for the preparation of alkoxy end-capped polydiorganosiloxanes, by end-capping silanol terminated polydiorganosiloxanes. This also relates to the use of alkoxy end-capped polydiorganosiloxanes as one of the essential constituents of condensation curable polydiorganosiloxane elastomer compositions which are stable in storage, in the absence of moisture, and which are cross-linked by atmospheric moisture at ambient temperature.

Several routes are known in the art for the preparation of polydiorganosiloxane polymers having alkoxy end groups. It is known in the art that polydiorganosiloxane polymers having alkoxy end groups may be prepared by reacting di-, tri- or tetra alkoxy silanes (poly alkoxysilanes) with silanol-terminated polydiorganosiloxane polymers in the presence of a catalyst.

The reaction is not as straightforward as might be anticipated. In fact, silanol groups do not readily react with alkoxysilane groups at ambient temperatures in the absence of catalyst. A wide variety of compounds have been proposed as suitable catalysts for this purpose. Some, e.g. sulphuric acid, hydrochloric acid, Lewis acids, sodium hydroxide, potassium hydroxide and tetramethylammonium hydroxide are generally chemically severe and when involved in the condensation of silanols with alkoxy silanes, have been found to cause bond scission and random rearrangement. Other compounds which have been proposed as suitable catalysts including amines, inorganic oxides, potassium acetate, titanium/amine combinations, carboxylic acid/amine combinations, alkoxyaluminum chelates, N,N′-disubstituted hydroxylamines, carbamates, metal hydroxides such as lithium hydroxide, and oxime-containing organic compounds are undesired for a variety of reasons. For example, amine catalyst systems are slow, particularly given the level of reactivity of many of the alkoxysilanes involved in the process. In addition, amine and carboxylic acid catalysts are corrosive and require special handling and removal processes once the reaction has proceeded to the desired state of completion. Lithium hydroxide, being an inorganic solid, requires a polar solvent such as methanol to introduce it as a solution into the reaction. However, the presence of methanol leads to a continual regeneration of the catalyst, e.g. in the form of lithium methoxide, and consequently, the resultant polymer reaction product exhibits a rapid lowering of viscosity due to interaction with said regenerated lithium catalyst. Furthermore, many of these catalysts can release displeasing odours and are dangerous to eyes and skin, and their removal is often difficult, requiring extra steps which are laborious and costly.

Organic titanium catalysts, such as titanium tetraisoproprionate, have been previously considered for the preparation of alkoxy end-capped polydiorganosiloxane polymers but they form complexes with the silanol terminated polydiorganosiloxane starting materials which leads to significant thickening of the polymer matrix. Whilst this titanium-silicon complexing is reversible, it requires high shear mixing to breakdown the thick phase which is undesirable for industry because of the additional cost and time required.

Additionally, the inability to remove catalysts can be detrimental to the storage stability of the polymer reaction product or compositions containing the polymer, because of e.g. gelling due to cross-linking or polymer growth or polymer chain scission (sometimes referred to as pre-cure reversion). Furthermore, the inability to remove some of the amine catalysts completely may lead to discolouration either during the storage of the compound or of subsequently prepared sealant, adhesive, caulk compositions and the like and/or their respective elastomeric products upon cure.

Hence, a need remains for a process for making viscosity-stable alkoxy-terminated polydiorganosiloxane polymers by end-capping silanol-terminated polydiorganosiloxanes quickly using a catalyst which does not suffer from the disadvantages of the prior art catalysts.

There is provided herein a process for preparing an alkoxy-terminated polydiorganosiloxane from a silanol-terminated polydiorganosiloxane starting material comprising:
(i) reacting said silanol terminated polydiorganosiloxane starting material with one or more polyalkoxy silane starting material(s) of the structure

(R²—O)_{(4-b)}—Si—R¹_{b}

where b is 0, 1 or 2, R² is an alkyl group which may be linear or branched having from 1 to 15 carbons and R¹ may be any suitable group i.e. a monovalent hydrocarbon radical such as R² cycloalkyl groups; alkenyl groups, aryl groups; aralkyl groups aminoalkyl groups, (meth)acrylate groups, glycidylether groups and groups obtained by replacing all or part of the hydrogen in the preceding organic groups with halogen;
in the presence of an end-capping catalyst starting material consisting of one or more linear, branched or cyclic molecules comprising at least one amidine group, guanidine group, or derivatives of said amidine group and/or guanidine group or a mixture thereof in an amount of from 0.0005 to 0.75 wt. % of the starting materials composition and upon completion of the reaction.

There is also provided herein an alkoxy end-capped, polydiorganosiloxane polymer obtainable or obtained by (i) reacting a silanol terminated polydiorganosiloxane starting material with one or more polyalkoxy silane starting material(s) of the structure

(R²—O)_{(4-b)}—Si—R¹_{b}

where b is 0, 1 or 2, R² is an alkyl group which may be linear or branched having from 1 to 15 carbons and R¹ may be any suitable group i.e. a monovalent hydrocarbon radical such as R², cycloalkyl groups; alkenyl groups, aryl groups; aralkyl groups aminoalkyl groups, (meth)acrylate groups, glycidylether groups and groups obtained by replacing all or part of the hydrogen in the preceding organic groups with halogen;
in the presence of
an end-capping catalyst starting material consisting of one or more linear, branched or cyclic molecules comprising at least one amidine group, guanidine group, or derivatives of said amidine group and/or guanidine group or a mixture thereof in an amount of from 0.0005 to 0.75 wt. % of the starting materials composition.

There is also provided herein a process for preparing an alkoxy end-capped, polydiorganosiloxane from a silanol-terminated polydiorganosiloxane as described above and then preparing a polydiorganosiloxane elastomer composition, by mixing the following components together:
(a) said alkoxy end-capped, polydiorganosiloxane polymer obtained by way of the process described herein;
   (b) filler;
   (d) a condensation cure catalyst; and optionally
   (e) adhesion promoter and/or
   (c) a cross-linker.

There is also provided the use of an alkoxy end-capped, polydiorganosiloxane polymer prepared by way of the process described herein as a polymer in the preparation of an organopolysiloxane elastomer composition.

The silanol terminated polydiorganosiloxane starting material has at least two silanol groups per molecule and may have the formula

(HO)₃₋ₙRₙSi—(Z)_{d}—(O)_{q}—(R_{y}SiO_{(4-y)/2})_{z}—(SiR₂—Z)_{d}—Si—Rₙ(OH)₃₋ₙ (1)

in which each R is an alkyl, alkenyl or aryl group, and Z is a divalent organic group;
d is 0 or 1, q is 0 or 1 and d+q=1; n is 0, 1 or 2, y is 0, 1 or 2, and z is an integer such that said polydiorganosiloxane polymer starting material has a viscosity of from 30 to 100,000 mPa·s at 25° C., alternatively from 1,000 to 90,000 mPa·s at 25° C., using either a Brookfield® rotational viscometer with spindle LV-4 (designed for viscosities in the range between 1,000-2,000,000 mPa·s) or a Brookfield® rotational viscometer with spindle LV-1 (designed for viscosities in the range between 15-20,000 mPa·s) for viscosities less than 1000 mPa·s and adapting the speed (shear rate) according to the polymer viscosity.

Typically in the above d is 0, q is 1 and n is 1 or 2. In such a case the silanol terminated polydiorganosiloxane starting material has the following structure:

(OH)₃₋ₙRₙSi—O—(R_{y}SiO_{(4-y)/2})_{z}—Si—Rₙ(OH)₃₋ₙ

With R, y and z being as described above, the average value of y is about 2, i.e. the silanol terminated polymer is substantially (i.e. greater than (>) 90% linear, alternatively >97% linear).

Each R is individually selected from alkyl groups, alternatively alkyl groups having from 1 to 10 carbon atoms, alternatively from 1 to 6 carbon atoms, alternatively 1 to 4 carbon atoms, alternatively methyl or ethyl groups; alkenyl groups alternatively alkenyl groups having from 2 to 10 carbon atoms, alternatively from 2 to 6 carbon atoms such as vinyl, allyl and hexenyl groups; aromatic groups, alternatively aromatic groups having from 6 to 20 carbon atoms, substituted aliphatic organic groups such as 3,3,3-trifluoropropyl groups, aminoalkyl groups, polyaminoalkyl groups, and/or epoxyalkyl groups.

Each Z is independently selected from an alkylene group having from 1 to 10 carbon atoms. In one alternative each Z is independently selected from an alkylene group having from 2 to 6 carbon atoms; in a further alternative each Z is independently selected from an alkylene group having from 2 to 4 carbon atoms. Each alkylene group may for example be individually selected from an ethylene, propylene, butylene, pentylene and/or hexylene group. However, as previously indicated in the present instance d is usually 0 (zero).

The silanol terminated polydiorganosiloxane starting material has a viscosity of from viscosity of from 1,000 to 100,000 mPa·s at 25° C., alternatively from 5,000 to 90,000 mPa·s at 25° C. using either a Brookfield® rotational viscometer with spindle LV-4 (designed for viscosities in the range between 1,000-2,000,000 mPa·s or a Brookfield® rotational viscometer with spindle LV-1 (designed for viscosities in the range between 15-20,000 mPa·s) for viscosities less than 1000 mPa·s and adapting the speed (shear rate) according to the polymer viscosity; z is therefore an integer enabling such a viscosity, alternatively z is an integer from 200 to 5000.

The silanol terminated polydiorganosiloxane starting material can be a single siloxane represented by Formula (1) or it can be mixtures of polydiorganosiloxane polymers represented by the aforesaid formula. Hence, the term “siloxane polymer mixture” in respect to the silanol terminated polydiorganosiloxane starting material is meant to include any individual polydiorganosiloxane polymer starting material or mixtures of polydiorganosiloxane polymer starting materials.

The Degree of Polymerization (DP), (i.e. in the above formula substantially z), is usually defined as the number of monomeric units in a macromolecule or polymer or oligomer molecule of silicone. Synthetic polymers invariably consist of a mixture of macromolecular species with different degrees of polymerization and therefore of different molecular weights. There are different types of average polymer molecular weight, which can be measured in different experiments. The two most important are the number average molecular weight (Mn) and the weight average molecular weight (Mw). The Mn and Mw of a silicone polymer can be determined by gel permeation chromatography (GPC) with precision of about 10-15%. This technique is standard and yields Mw, Mn and polydispersity index (PI). The degree of polymerisation (DP)=Mn/Mu where Mn is the number-average molecular weight coming from the GPC measurement and Mu is the molecular weight of a monomer unit. PI=Mw/Mn. The DP is linked to the viscosity of the polymer via Mw, the higher the DP, the higher the viscosity.

In a first stage of the process the silanol terminated polydiorganosiloxane starting material described above is reacted with a one or more polyalkoxy silane starting material(s) of the structure

(R²—O)_{(4-b)}—Si—R¹_{b}

where b is 0, 1 or 2, alternatively 0 or 1; R² is an alkyl group having from 1 to 15 carbons, alternatively from 1 to 10 carbons, alternatively from 1 to 6 carbons and may be linear or branched, for example methyl, ethyl, propyl, n-butyl, t-butyl, pentyl and hexyl, alternatively methyl or ethyl, alternatively R² may be a methyl group. R¹ may be any suitable group, i.e. a monovalent hydrocarbon radical such as R² which may be substituted or unsubstituted e.g. substituted by halogen such as fluorine and chlorine e.g. trifluoropropyl and/or perfluoropropyl; cycloalkyl groups (for example cyclopentyl and cyclohexyl); alkenyl groups (for example vinyl and allyl); aryl groups (for example phenyl, and tolyl); aralkyl groups (for example 2-phenylethyl) and groups obtained by replacing all or part of the hydrogen in the preceding organic groups with halogen. In one embodiment R¹ may be a vinyl, methyl or ethyl, group, alternatively a vinyl or methyl group alternatively a methyl group. When b is 0 or 1 this means that the polyalkoxysilane has either 4 or 3 alkoxy groups. Typically, the silanol terminated polydiorganosiloxane starting material has one terminal silanol bond (—Si—OH) per terminal silicon, in such a case the end-capping reaction will generate terminal groups replacing the (—Si—OH) including 3 Si-alkoxy bonds or two Si-alkoxy bonds and e.g. an alkyl or vinyl or the like.

Typically the amount of polyalkoxy silane starting material(s) present in the starting materials for the end-capping reaction is determined so that there is at least an equimolar amount of polyalkoxy silane present relative to the amount of —OH groups on the polymer. Hence, the greater the viscosity/chain length of the polymer used as a starting material, typically the less —OH groups present in the polymer and consequently less polyalkoxy silane is required. Equally the opposite is correct i.e. the smaller the viscosity/chain length of the polymer used as a starting material, typically the greater the number of —OH groups present in the polymer starting material and consequently a greater amount of polyalkoxy silane is required. However, in some instances there is a preference to include a significant molar excess of polyalkoxy silane and the remaining unreacted polyalkoxy silane present at the end of the end-capping reaction i.e. in the alkoxy end-capped, polydiorganosiloxane polymer reaction end-product is then utilised as a cross-linker if/when the alkoxy end-capped, polydiorganosiloxane polymer reaction end-product is used as an ingredient in an organopolysiloxane elastomer composition for use as e.g. a silicone sealant composition. Hence, in one embodiment herein preferably there is a molar excess of polyalkoxy silane with respect to —OH groups on the polymer being end-capped. Hence, alkoxy end-capped, polydiorganosiloxane polymer reaction end-product may be alkoxy end-capped, polydiorganosiloxane polymer or alkoxy end-capped, polydiorganosiloxane polymer mixed with/containing unreacted polyalkoxy silane.

The end-capping catalyst starting material utilised in accordance with the disclosure herein is selected from one or more linear, branched or cyclic molecules comprising one or more groups selected from amidine groups, guanidine groups, derivatives of said amidine groups and/or guanidine groups or a mixture thereof.

The one or more linear, branched or cyclic molecules comprising one or more groups selected from amidine groups, guanidine groups, derivatives of said amidine groups and/or guanidine groups or a mixture thereof may comprise linear, branched or cyclic silicon containing molecules or linear, branched or cyclic organic molecules containing one or more of the groups (1) to (4) depicted below.

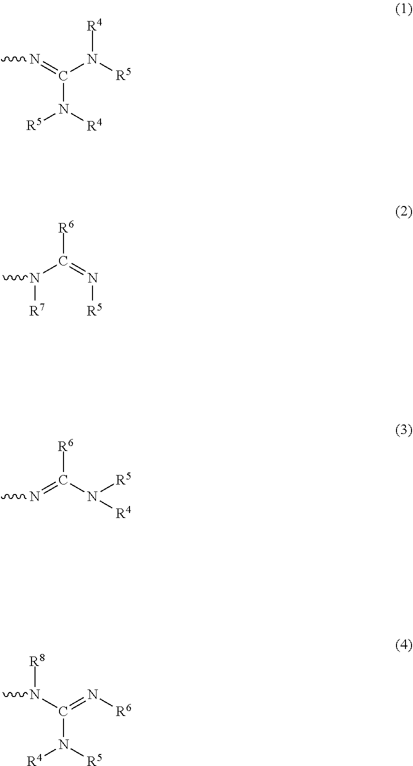

Wherein each R⁴, R⁵, R⁶, R⁷ and R⁸ may be the same or different and may be selected from hydrogen, an alkyl group, a cycloalkyl group, a phenyl group, an aralkyl group or alternatively R⁴ and R⁵ or R⁶ and R⁵ or R⁷ and R⁵ or R⁸ and R⁴ may optionally form ring structure, for example a heterogeneously substituted alkylene group to form a ring structure, wherein the heterogeneous substitution is by means of an oxygen or nitrogen atom.

In one embodiment formulas (1) to (4) may be part of a silane structure where the nitrogen is bonded to a silicon atom via an alkylene group, e.g.:

(R¹⁰)₃Si—Z-A

wherein Z is as hereinbefore described, each R¹⁰ may be the same or different and may be a hydroxyl and/or hydrolysable group (such as those described in relation to cross-linker (c) later in the description), an alkyl group; a cycloalkyl group; alkenyl group, aryl group or an aralkyl group; and A is one of (1) to (4) above.

In a further alternative any one of structures (1) to (4) above may be linked to a polymer radical selected from a group consisting of alkyd resins, oil-modified alkyd resins, saturated or unsaturated polyesters, natural oils, epoxides, polyamides, polycarbonates, polyethylenes, polypropylenes, polybutylenes, polystyrenes, ethylene-propylene copolymers, (meth)acrylates, (meth)acrylamides and salts thereof, phenolic resins, polyoxymethylene homopolymers and copolymers, polyurethanes, polysulphones, polysulphide rubbers, nitrocelluloses, vinyl butyrates, vinyl polymers, ethylcelluloses, cellulose acetates and/or butyrates, rayon, shellac, waxes, ethylene copolymers, organic rubbers, polysiloxanes, polyethersiloxanes, silicone resins, polyethers, polyetheresters and/or polyether carbonates. If structures (1) to (4) are linked to a siloxane radical they may be bonded to a polysiloxane radical having an average molecular weight in the range of from 206 to 50,000 g/mol, in particular 280 to 25,000 g/mol, particularly preferably 354 to 15,000 g/mol. An end-capping catalyst having such a polysiloxane radical is typically liquid at room temperature, has a low vapor pressure, is particularly readily compatible in curable compositions based on silicone polymers and in this context tends particularly little towards separation or migration.

For example, the end-capping catalyst starting material may be 1,1,3,3-tetramethylguanidine (TMG) having the structure (CH₃)₂N—C═NH(N(CH₃)₂) or may be a silane of the following structure

(R²—O)_{(4-a-b)}—Si—R³ₐR¹_{b}

where R², R¹ and b are as described above, a is 1 and R³ is —Z¹—N═C—(NR⁵R⁴)₂ in which R⁵ and R⁴ are as defined above, Z¹ is an alkylene or an oxyalkylene group having from 2 to 6 carbons and a is 1.
Specific examples include, 2-[3-(trimethoxysilyl)propyl]-1,1,3,3-tetramethylguanidine and 2-[3-(methyldimethoxysilyl)propyl]-1,1,3,3-tetramethylguanidine.

Alternatively, the end-capping catalyst starting material may be a cyclic guanidine such as for example, Triazabicyclodecene (1,5,7-Triazabicyclo[4.4.0]dec-5-ene (TBD) as depicted below:

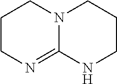

or 7-Methyl-1,5,7-triazabicyclo[4.4.0]dec-5-ene (mTBD) as depicted below

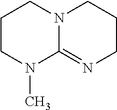

Alternatively, the end-capping catalyst starting material may be a cyclic amidine such as for example, 1,5-Diazabicyclo[4.3.0]non-5-ene (DBN) as depicted below

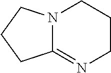

or 1,8-diazabicyclo[5.4.0]undec-7-ene (DBU) as depicted below

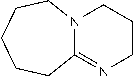 [SMILES: C1CCC2=NCCCN2CC1]

When the reaction can be continuously mixed (e.g., magnetic stir bar or overhead mechanical stirrer), the end-capping catalyst can be added directly as a solid. Furthermore, if the end-capping catalyst can be introduced into the reaction environment in the form of a fine powder. If the reaction will be mixed and allowed to rest, then the end-capping catalyst is delivered as a solution to ensure homogenous dispersion. When delivered in solution the solvent may be a compatible silicone or organic solvent such as, for the sake of example, trimethyl terminated polydimethylsiloxane or toluene. However, to minimise VOC issues it was found that a preferable liquid for delivery of the end-capping catalyst was, in actual fact, the or one of the polyalkoxysilanes being utilised to end-cap the silanol-terminated polydiorganosiloxane starting material, for example vinyl trimethoxy silane and/or methyl trimethoxy silane.

A major advantage herein is the ability to cap the polymer whilst maintaining the stability of the polymer viscosity as the process minimizes cross-linking or polymer growth. By stability we mean a period of from 3 to 7 days without a significant change (i.e. greater than (>) 10% of the alkoxy end-capped polydiorganosiloxane polymers) due to cross-linking or gelling, or alternatively scission or the like. This may be determined by periodic testing of samples by quantitative NMR (determining degree of polymerisation) or by viscosity measurement. The NMR used was Proton NMR measured using a 400 MHz instrument using deuterated solvent (e.g., CDCl₃ δ 7.26) as internal standard. ²⁹Si NMR is measured by 80 MHz instrument using a solution of 0.02 M Chromium(III) acetylacetonate (Cr(acac)₃) in deuterated solvent (e.g., deuterated chloroform (CDCl₃)). Viscosity was measured by TA Instruments ARES Rheometer using cone and plate geometry with 0.051 mm gap. Viscosities were reported as average viscosity between 1 and 10 s⁻¹ with ten points per decade on a logarithmic scale.

Typically the end-capping process described above is carried out in the absence of other ingredients, however, if required additional ingredients which will not interfere with the end-capping process described herein such as plasticisers/extenders and or pigments may be present in the composition prior to the process, if desired. However, these are generally added during subsequent preparation of compositions utilising the end-capped polymer provided by the process herein, as discussed later in the description.

Furthermore, if desired, prior to or even concurrently with the process hereinbefore described, chain-extenders may be introduced to extend the length of the polymer chain prior to end-capping with the alkoxysilanes. The chain-extenders, may, for the sake of example, be difunctional silanes. Suitable difunctional silanes may have the following structure

(R¹)₂—Si—(R¹²)₂

Wherein each R¹¹ may be the same or different and may be linear, branched or cyclic but is a non-functional group, in that it is unreactive with the —OH groups or hydrolysable groups of the silanol terminated polydiorganosiloxane starting material. Hence, each R¹¹ group is selected from an alkyl group having from 1 to 10 carbon atoms, an alkenyl group, an alkynyl group or an aryl group such as phenyl. In one alternative the R¹¹ groups are either alkyl groups or alkenyl groups, alternatively there may be one alkyl group and one alkenyl group per molecule. The alkenyl group may for example be selected from a linear or branched alkenyl groups such as vinyl, propenyl and hexenyl groups and the alkyl group has from 1 to 10 carbon atoms, such as methyl, ethyl or isopropyl. In a further alternative R¹¹ may be replaced by R¹¹¹ which is cyclic and bonds to the Si atom in two places.

Each group R¹² may be the same or different and is reactable with the hydroxyl or hydrolysable groups. Examples of group R¹² include alkoxy, acetoxy, oxime, hydroxy and/or acetamide groups. Alternatively, each R¹² is either an alkoxy group or an acetamide group. When R¹² is an alkoxy group, said alkoxy groups containing between 1 and 10 carbon atoms, for example methoxy, ethoxy, propoxy, isoproproxy, butoxy, and t-butoxy groups. Specific examples of suitable difunctional silane chain-extenders, herein include, alkenyl alkyl dialkoxysilanes such as vinyl methyl dimethoxysilane, vinyl ethyldimethoxysilane, vinyl methyldiethoxysilane, vinylethyldiethoxysilane, alkenylalkyldioximosilanes such as vinyl methyl dioximosilane, vinyl ethyldioximosilane, vinyl methyldioximosilane, vinylethyldioximosilane, alkenylalkyldiacetoxysilanes such as vinyl methyl diacetoxysilane, vinyl ethyldiacetoxysilane, vinyl methyldiacetoxysilane, vinylethyldiacetoxysilane and alkenylalkyldihydroxysilanes such as vinyl methyl dihydroxysilane, vinyl ethyldihydroxysilane, vinyl methyldihydroxysilane and vinylethyldihydroxysilane.

When R¹² is an acetamide the disilane may be a dialkyldiacetamidosilane or an alkylalkenyldiacetamidosilane. Such diacetamidosilanes are known chain-extending materials for low modulus sealant formulations as described in for example U.S. Pat. Nos. 5,017,628 and 3,996,184. The diacetamidosilanes may for example have the structure

CH₃—C(═O)—NR¹³—Si(R¹⁴)₂—NR¹³—C(═O)—CH₃

wherein each R¹³ may be the same or different and may be the same as R as defined above, alternatively, each R¹³ may be the same or different and may comprise an alkyl group having from 1 to 6 carbons, alternatively 1 to 4 carbons. Each R¹⁴ may also be the same or different and may also be the same as R as defined above comprise an alkyl group having from 1 to 6 carbons, alternatively 1 to 4 carbons or an alkenyl group having from 2 to 6 carbons, alternatively 2 to 4 carbons, alternatively vinyl. In use the diacetamidosilanes may be selected from one or more of the following:
N,N′-(dimethylsilylene)bis[N-methylacetamide]
N,N′-(dimethylsilylene)bis[N-ethylacetamide]
N,N′-(diethylsilylene)bis[N-methylacetamide]
N,N′-(diethylsilylene)bis[N-ethylacetamide]
N,N′-(dimethylsilylene)bis[N-propylacetamide]
N,N′-(diethylsilylene)bis[N-propylacetamide]
N,N′-(dipropylsilylene)bis[N-methylacetamide]
N,N′-(dipropylsilylene)bis[N-ethylacetamide]
N,N′-(methylvinylsilylene)bis[N-ethylacetamide]
N,N′-(ethylvinylsilylene)bis[N-ethylacetamide]
N,N′-(propylvinylsilylene)bis[N-ethylacetamide]
N,N′-(methylvinylsilylene)bis[N-methylacetamide]
N,N′-(ethylvinylsilylene)bis[N-methylacetamide] and/or
N,N′-(propylvinylsilylene)bis[N-methylacetamide].

In an alternative, the dialkyldiacetamidosilane may be a dialkyldiacetamidosilane selected from N,N′-(dimethylsilylene)bis[N-ethylacetamide] and/or N,N′-(dimethylsilylene)bis[N-methylacetamide]. Alternatively, the dialkyldiacetamidosilane is N,N′-(dimethylsilylene)bis[N-ethylacetamide].

When present, the chain-extenders are present in an amount of from 0.01 to 5 wt. % of the composition, alternatively 0.05 to 1 wt. %.

When the above process is undertaken it may comprise (in the absence of additional steps, e.g. to make a final sealant or the like composition), based on the weight of the final mixture:
(ai) silanol terminated polydiorganosiloxane starting material in an amount of from 40 wt. % to 99.5 wt. % of the ingredients, alternatively 60 to 99.5 wt. % of the starting materials, alternatively from 70 to 99.5 wt. % of the ingredients, alternatively from 80 to 99.5 wt. % of the starting materials alternatively from 90 to 99.5 wt. % of the starting materials, alternatively from 95 to 99.5 wt. % of the starting materials;
(aii) one or more polyalkoxy silanes of the structure

(R²—O)_{(4-b)}—Si—R¹_{b}

where b is 0, 1 or 2, R² is an alkyl group which may be linear or branched having from 1 to 15 carbons and R¹ may be any suitable group i.e. a monovalent hydrocarbon radical such as R², cycloalkyl groups; alkenyl groups, aryl groups; aralkyl groups and groups obtained by replacing all or part of the hydrogen in the preceding organic groups with halogen; in an amount of from about 0.5 to 60 wt. % of the starting materials, alternatively 0.5 to 40 wt. % of the starting materials, 0.5 to 30 wt. % of the starting materials, 0.5 to 20% of the starting materials, 0.5 to 10 wt. % of the ingredients, alternatively 0.5 to 5 wt. % of the ingredients, alternatively 0.25 to 2.5 wt. % of the starting materials, and
(aiii) an end-capping catalyst consisting of one or more linear, branched or cyclic molecules comprising at least one amidine group, guanidine group, or derivatives of said amidine group and/or guanidine group or a mixture thereof in an amount of from 0.0005 to 0.75 wt. % of the starting materials. It will be appreciated that the total weight % (wt. %) of the starting ingredients is 100 wt. %.

It has been determined that, whilst neutralizing the end-capping catalyst within the final product has been a significant issue in prior art processes, given the low end-capping catalyst content in the present process, there is no need to remove the end-capping catalyst at the end of the reaction. Neutralization can come in the form of physical removal of the end-capping catalyst, chemical neutralisation (e.g., acid/base reaction), chemisorption (e.g., adsorption or sequestration), or other standard practices of product purification and end-capping catalyst removal. Furthermore, it is known that some amidines and guanidines can have a quite pungent aroma but given the amount of end-capping catalyst present it has been found that this is not a significant issue in the current process. A further advantage of the present disclosure is that even without removal, the level of addition of the end-capping catalyst negates the need for a neutralisation step.

In one embodiment typically, the silanol terminated polydiorganosiloxane starting material (ai) is introduced into a suitable mixer and is stirred; the one or more polyalkoxy silanes (aii) is then added and the resulting mixture is mixed again. Any suitable mixing time can be used for step (i) e.g. 10 to 30 minutes, alternatively 10 to 20 minutes. Optionally the mixing in step (i) may be carried out at an elevated temperature of up to about 100° C., e.g. 30 to 100° C., alternatively 50 to 80° C. The end-capping catalyst may be introduced prior to, simultaneously with or subsequent to the addition of the one or more polyalkoxy silanes as deemed necessary.

The resulting alkoxy end-capped, polydiorganosiloxane polymer reaction end-product may, be isolated from by-products and end-capping catalysts etc. if desired. Alternatively, an equimolar amount of polymer (ai) and polyalkoxy silane (aii) starting materials may be utilised in the reaction process so that there is no excess of polyalkoxy silane (aii) starting materials but equally if desired an excess of polyalkoxy silane (aii) starting materials may be added into the above reaction mixture, with the intention of any excess polyalkoxy silanes (aii) being utilised as cross-linker (c) or part of cross-linker (c) in the preparation of a polydiorganosiloxane elastomer composition.

In the event it is desired for the polymer to be chain-extended, a chain extension process step is also undertaken. Typically in this case the chain-extender is added in a first step instead of the one or more polyalkoxy silanes and then after a chain-extension step, involving the end-capping catalyst as described above is considered completed the polyalkoxy silanes are introduced into the mixture with the intention of end-capping the chain-extended polymer. The mixing may take place in any suitable type of mixer e.g. a speedmixer or Turello mixer. Alternatively, the chain-extending silane and end-capping silane may be added simultaneously if the silanes are different. Alternatively, the chain-extending silane and end-capping silane may be added separately if they are the same silane.

Similarly, as previously indicated it is unnecessary to neutralise the end product, unlike in most prior art methodologies providing the alkoxy end-capped polymer is to be utilised within a period of no more than 3 to 7 days from production.

The resulting alkoxy end-capped polymer reaction end-product may be collected and stored for future use within a period of 3 to 7 days from production but is preferably used immediately as part of a process for the preparation of a polydiorganosiloxane elastomer composition comprising:
(a) An alkoxy end-capped polydiorganosiloxane prepared as hereinbefore described, i.e. the alkoxy end-capped polymer reaction end-product;
(b) filler;
(c) cross-linker,
(d) condensation cure catalyst;
and optionally
(e) adhesion promoter.

It is to be noted that the cross-linker may be supplied with end-capped polymer (a) in an end-capping reaction end product as an unreacted excess of polyalkoxy silane which may be used as the cross-linker of the composition. Alternatively, if the polyalkoxy silane was used to completion in the end-capping reaction, cross-linker may be added. Alternatively, if the polyalkoxy silane was used to completion in the end-capping reaction, cross-linker may be added, otherwise the cross-linker may be a mixture of the two, partially excess and partly added at this stage fresh.

The alkoxy end-capped polydiorganosiloxane (a), is typically present in the composition in an amount of from 40 to 80% wt. % of a polydiorganosiloxane elastomer composition, alternatively from about 40 to 65% wt. % of the sealant composition.

The above composition is suitable as a sealant elastomer composition and may be designed to form a product upon cure having a low modulus and/or which is non-staining in that plasticizers and/or extenders (sometime referred to as processing aids) do not leech out and stain neighbouring substrates such as concrete blocks or other building materials.

Typically if a low modulus sealant composition is desired, the polymer made by the process described herein would have been chain-extended as discussed above so that the alkoxy end-capped polymer (a) is designed to be of a high molecular weight/chain length.

Filler (b) may comprise reinforcing filler and/or non-reinforcing filler, for example one or more finely divided, reinforcing fillers fumed silica, colloidal silica and/or precipitated silica and/or may include other fillers as desired such as precipitated calcium carbonate and ground calcium carbonate. Typically, the surface area of the filler (b) is at least 15 m²/g in the case of precipitated calcium carbonate measured in accordance with the BET method in accordance with ISO 9277: 2010, alternatively 15 to 50 m²/g, alternatively, 15 to 25 m²/g in the case of precipitated calcium carbonate. Silica reinforcing fillers have a typical surface area of at least 50 m²/g. In one embodiment filler (b) is a precipitated calcium carbonate, precipitated silica and/or fumed silica; alternatively, precipitated calcium carbonate. In the case of high surface area fumed silica and/or high surface area precipitated silica, these may have surface areas of from 75 to 400 m²/g measured using the BET method in accordance with ISO 9277: 2010, alternatively of from 100 to 300 m²/g using the BET method in accordance with ISO 9277: 2010.

Typically, the reinforcing fillers (b) are present in the composition in an amount of from about 5 to 45 wt. % of the composition, alternatively from about 5 to 30 wt. % of the composition, alternatively from about 5 to 25 wt. % of the composition, depending on the chosen filler.

Filler (b) may be hydrophobically treated for example with one or more aliphatic acids, e.g. a fatty acid such as stearic acid or a fatty acid ester such as a stearate, or with organosilanes, organosiloxanes, or organosilazanes e.g. hexaalkyl disilazane or short chain siloxane diols to render the filler(s) (b) hydrophobic and therefore easier to handle and obtain a homogeneous mixture with the other adhesive components. The surface treatment of the fillers makes them easily wetted by alkoxy end-capped polydiorganosiloxane (a). These surface modified fillers do not clump and can be homogeneously incorporated into the alkoxy end-capped polydiorganosiloxane (a) of the base component. This results in improved room temperature mechanical properties of the uncured compositions. The fillers may be pre-treated or may be treated in situ when being mixed with alkoxy end-capped polydiorganosiloxane (a).

The sealant composition also comprises a condensation cure catalyst (d). Any suitable condensation cure catalyst (d) may be utilised. Said condensation cure catalyst, may comprise one or more tin-based catalysts such as for example tin triflates, organic tin-based cure catalysts such as triethyltin tartrate, tin octoate, tin oleate, tin naphthenate, butyltintri-2-ethylhexoate, tin butyrate, carbomethoxyphenyl tin trisuberate, isobutyltintriceroate, and diorganotin salts especially diorganotin dicarboxylate compounds such as dibutyltin dilaurate (DBTDL), dioctyltin dilaurate (DOTDL), dimethyltin dibutyrate, dibutyltin dimethoxide, dibutyltin diacetate, dimethyltin bisneodecanoate, dibutyltin dibenzoate, stannous octoate, dibutyltin bis(2,4-pentanedionate, dimethyltin dineodecanoate (DMTDN) and dibutyltin dioctoate.

Alternatively or additionally the condensation cure catalyst (d) may comprise a titanate and/or zirconate based catalyst e.g. according to the general formula Ti[OR²²]₄ or Zr[OR²²]₄ where each R²² may be the same or different and represents a monovalent, primary, secondary or tertiary aliphatic hydrocarbon group which may be linear or branched containing from 1 to 10 carbon atoms. Optionally the titanate and/or zirconate may contain partially unsaturated groups. Examples of R²² include but are not restricted to methyl, ethyl, propyl, isopropyl, butyl, tertiary butyl and a branched secondary alkyl group such as 2,4-dimethyl-3-pentyl. Alternatively, when each R²² is the same, R²² is an isopropyl, branched secondary alkyl group or a tertiary alkyl group, in particular, tertiary butyl. In one alternative the catalyst is a titanate. Suitable titanate examples include tetra n-butyl titanate, tetra t-butyl titanate, titanium tetrabutoxide and tetraisopropyl titanate. Suitable zirconate examples include tetra-n-propyl zirconate, tetra-n-butyl zirconate and zirconium diethylcitrate.

Alternatively, the titanate and/or zirconate may be chelated. The chelation may be with any suitable chelating agent such as an alkyl acetylacetonate such as methyl or ethyl acetylacetonate. Alternatively, the titanate may be monoalkoxy titanates bearing three chelating agents such as for example 2-propanolato, tris isooctadecanoato titanate or Diisopropoxy-bisethylacetoacetatotitanate.

Condensation cure catalyst (d) is typically present in the composition in an amount of from 0.25 to 4.0 wt. % of the composition, alternatively from 0.25 to 3 wt. % of the composition, alternatively from 0.3 wt. % to 2.5 wt. % of the composition. The polydiorganosiloxane elastomer composition may be a one-part composition wherein all the ingredients of the composition are stored together or may be a two-part composition wherein ingredients are stored in two-parts before use to prevent premature curing.

In a preferred embodiment the polydiorganosiloxane elastomer composition herein is a one-part polydiorganosiloxane elastomer composition, preferably a one-part polydiorganosiloxane elastomer composition wherein condensation cure catalyst (d) is a tin-based condensation cure catalyst.

The separate addition of a cross-linker (c) into said polydiorganosiloxane elastomer composition is, during the preparation of the said composition, optional. This is because whilst an essential ingredient in said polydiorganosiloxane elastomer composition, the cross-linker (c) may be the same as the one or more polyalkoxy silanes of the structure (R²—O)_{(4-b)}—Si—R¹_{b} used in the end-capping reaction described above, wherein R², R¹ and b are as described before. When this is the case it is possible for the polyalkoxy silanes to be introduced into the reaction mixture for end-capping the silanol polymer in sufficient excess at the time of the end-capping reaction that no additional cross-linking agent (c) is required at the time of preparing the polydiorganosiloxane elastomer composition. However, if deemed necessary additional cross-linker(s) may be added at the time of preparing the polydiorganosiloxane elastomer composition.

When an amount of cross-linker (c) is added at the time of preparing the polydiorganosiloxane elastomer composition, any suitable cross-linker having at least three groups per molecule which are reactable with the alkoxy end-capped polydiorganosiloxane (a) may be utilised. Typically, any cross-linker (c) added is one or more silanes or siloxanes which contain silicon bonded hydrolysable groups such as acyloxy groups (for example, acetoxy, octanoyloxy, and benzoyloxy groups); ketoximino groups (for example dimethyl ketoximo, and isobutylketoximino); alkoxy groups (for example methoxy, ethoxy, iso-butoxy and propoxy) and alkenyloxy groups (for example isopropenyloxy and 1-ethyl-2-methylvinyloxy).

When cross-linking agent (c) is required, it may comprise siloxane based cross-linkers having a straight chained, branched, or cyclic molecular structure.

Cross-linker (c) has at least three or four hydroxyl and/or hydrolysable groups per molecule which are reactive with the hydroxyl and/or hydrolysable groups in alkoxy end-capped polydiorganosiloxane (a). When cross-linker (c) is required to be added, the cross-linker (c) may alternatively be a silane and when the silane has a total of three silicon-bonded hydroxyl and/or hydrolysable groups per molecule, the fourth group is suitably a non-hydrolysable silicon-bonded organic group. These silicon-bonded organic groups are suitably hydrocarbyl groups which are optionally substituted by halogen such as fluorine and chlorine. Examples of such fourth groups include alkyl groups (for example methyl, ethyl, propyl, and butyl); cycloalkyl groups (for example cyclopentyl and cyclohexyl); alkenyl groups (for example vinyl and allyl); aryl groups (for example phenyl, and tolyl); aralkyl groups (for example 2-phenylethyl) and groups obtained by replacing all or part of the hydrogen in the preceding organic groups with halogen. Preferably however, the fourth silicon-bonded organic group is methyl or vinyl.

Silanes and siloxanes which can be used as cross-linker (c) include alkyltrialkoxysilanes such as methyltrimethoxysilane (MTM) and methyltriethoxysilane, alkenyltrialkoxy silanes such as vinyltrimethoxysilane and vinyltriethoxysilane, isobutyltrimethoxysilane (iBTM). Other suitable silanes include ethyltrimethoxysilane, vinyltriethoxysilane, phenyltrimethoxysilane, alkoxytrioximosilane, alkenyltrioximosilane, 3,3,3-trifluoropropyltrimethoxysilane, methyltriacetoxysilane, vinyltriacetoxysilane, ethyl triacetoxysilane, di-butoxy diacetoxysilane, phenyl-tripropionoxysilane, methyltris(methylethylketoximo)silane, vinyl-tris-methylethylketoximo)silane, methyltris(methylethylketoximino)silane, methyltris(isopropenoxy)silane, vinyltris(isopropenoxy)silane, ethylpolysilicate, n-propylorthosilicate, ethylorthosilicate and/or dimethyltetraacetoxydisiloxane. Cross-linker (c) may alternatively comprise any combination of two or more of the above.

Alternatively, cross-linker (c) may comprise a silyl functional molecule containing two or more silyl groups, each silyl group containing at least one —OH or hydrolysable group, the total of number of —OH groups and/or hydrolysable groups per cross-linker molecule being at least 3. Hence, a disilyl functional molecule comprises two silicon atoms each having at least one hydrolysable group, where the silicon atoms are separated by an organic or siloxane spacer. Typically, the silyl groups on the disilyl functional molecule may be terminal groups. The spacer may be a polymeric chain having a siloxane or organic polymeric backbone. In the case of such siloxane or organic based cross-linkers (c) the molecular structure can be straight chained, branched, cyclic or macromolecular. In the case of siloxane-based polymers the viscosity of the cross-linker (c) will be within the range of from 15 mPa·s to 50,000 mPa·s at 25° C. measured using either a Brookfield® rotational viscometer with spindle LV-4 (designed for viscosities in the range between 1,000-2,000,000 mPa·s) or a Brookfield® rotational viscometer with spindle LV-1 (designed for viscosities in the range between 15-20,000 mPa·s) for viscosities less than 1000 mPa·s and adapting the speed (shear rate) according to the polymer viscosity and measurements were taken at 25° C.

For example, if required to be added, cross-linker (c) may be a disilyl functional polymer, that is, a polymer containing two silyl groups, each having at least one hydrolysable group such as described by the formula

RₙSi(X)₃₋ₙ—Z⁴—Si(X)₃₋ₙRₙ

where each R, and n may be individually selected as hereinbefore described above. Z⁴ is an alkylene (divalent hydrocarbon group), alternatively an alkylene group having from 1 to 10 carbon atoms, or further alternatively 1 to 6 carbon atoms or a combination of said divalent hydrocarbon groups and divalent siloxane groups.

Each X group may be the same or different and can be a hydroxyl group or a condensable or hydrolyzable group. The term “hydrolyzable group” means any group attached to the silicon which is hydrolyzed by water at room temperature. The hydrolyzable group X includes groups of the formula —OT, where T is an alkyl group such as methyl, ethyl, isopropyl, octadecyl, an alkenyl group such as allyl, hexenyl, cyclic groups such as cyclohexyl, phenyl, benzyl, beta-phenylethyl; hydrocarbon ether groups, such as 2-methoxyethyl, 2-ethoxyisopropyl, 2-butoxyisobutyl, p-methoxyphenyl or —(CH₂CH₂O)₂CH₃. The most preferred X groups are hydroxyl groups or alkoxy groups. Illustrative alkoxy groups are methoxy, ethoxy, propoxy, isopropoxy, butoxy, isobutoxy, pentoxy, hexoxy octadecyloxy and 2-ethylhexoxy; dialkoxy groups, such as methoxymethoxy or ethoxymethoxy and alkoxyaryloxy, such as ethoxyphenoxy. The most preferred alkoxy groups are methoxy or ethoxy.

Preferred di-silyl functional polymer cross-linkers have n=0 or 1, X=OMe and R⁴ being an alkylene group with 4 to 6 carbons.

Examples of disilyl polymeric cross-linkers with a silicone or organic polymer chain bearing alkoxy functional end groups include polydimethylsiloxanes having at least one trialkoxy terminal where the alkoxy group may be a methoxy or ethoxy group. Examples might include or 1,6-bis(trimethoxy silyl)hexane, hexamethoxydisiloxane, hexaethoxydisiloxane, hexa-n-propoxydisiloxane, hexa-n-butoxydisiloxane, octaethoxytrisiloxane, octa-n-butoxytrisiloxane and decaethoxy tetrasiloxane. In one embodiment the cross-linker may be one or more of vinyltrimethoxysilane, methyltrimethoxysilane and/or vinylmethyldimethoxysilane.

The compositions suitably contain cross-linker (c) in at least a stoichiometric amount as compared to alkoxy end-capped polydiorganosiloxane (a) described above, irrespective of whether it originates as an excess from the end-capping reaction or from addition thereof after completion of the end-capping reaction or a combination of the two. Hence, the amount present will also depend upon the particular nature of the cross-linker (c) utilised and in particular, the molecular weight of the molecule selected. The cross-linker is therefore typically present in the composition in an amount of from 0.1 to 5 wt. % of the composition but may potentially be present in a greater amount.

When present, component (e) is an adhesion promoter. Suitable adhesion promoters (e) may comprise alkoxysilanes of the formula R¹⁴ₕSi(OR¹⁵)₍₄₋ₕ₎, where subscript h is 1, 2, or 3, alternatively h is 3. Each R¹⁴ is independently a monovalent organofunctional group. R¹⁴ can be an epoxy functional group such as glycidoxypropyl or (epoxycyclohexyl)ethyl, an amino functional group such as aminoethylaminopropyl or aminopropyl, a methacryloxypropyl, a mercapto functional group such as mercaptopropyl or an unsaturated organic group. Each R¹⁵ is independently an unsubstituted, saturated hydrocarbon group of at least 1 carbon atom. R¹⁵ may have 1 to 4 carbon atoms, alternatively 1 to 2 carbon atoms. R¹⁵ is exemplified by methyl, ethyl, n-propyl, and iso-propyl.

Alternatively the adhesion promoter may be glycidoxypropyltrimethoxysilane or a multifunctional material obtained by reacting two or more of the above. For examples the reaction product of an alkylalkoxysilicone e.g. trimethoxymethylsilane; an aminoalkoxysilane, e.g. 3-aminopropyl trimethoxysilane and an epoxyalkoxysilane e.g. glycidoxypropyl trimethoxysilane; in a weight ratio of (i):(ii):(iii) of 0.1-6:0.1-5:1.

Examples of suitable adhesion promoters (e) may also include and molecules of the structure:

—(R′O)₃Si(CH₂)_{g}N(H)—(CH₂)_{q}NH₂

in which each R′ may be the same or different and is an alkyl group containing from 1 to 10 carbon atoms, g is from 2 to 10 and q is from 2 to 10.

The polydiorganosiloxane elastomer composition may comprise, when present, 0.01 wt. % to 2 wt. %, alternatively 0.05 to 2 wt. %, alternatively 0.1 to 1 wt. % of adhesion promoter based on the weight of the composition. Preferably, the speed of hydrolysis of the adhesion promoter should be lower than the speed of hydrolysis of the cross-linker in order to favour diffusion of the molecule towards the substrate rather than its incorporation in the product network.

Other additives may be used if necessary. These may include rheology modifiers, stabilizers such as anti-oxidants, UV and/or light stabilizers, pigments, —OH scavengers (moisture/water/alcohol) scavengers, (typically silazanes or the same compounds as those used as cross-linkers), plasticisers and/or extenders (sometimes identified as processing aids) and fungicides and/or biocides and the like; It will be appreciated that some of the additives are included in more than one list of additives. Such additives would then have the ability to function in all the different ways referred to.

Rheology modifiers which may be incorporated in moisture curable compositions according to the invention include silicone organic co-polymers such as those described in EP0802233 based on polyols of polyethers or polyesters; waxes such as polyamide waxes, non-ionic surfactants selected from the group consisting of polyethylene glycol, polypropylene glycol, ethoxylated castor oil, oleic acid ethoxylate, alkylphenol ethoxylates, copolymers or ethylene oxide and propylene oxide, and silicone polyether copolymers; as well as silicone glycols. For some systems these rheology modifiers, particularly copolymers of ethylene oxide and propylene oxide, and silicone polyether copolymers, may enhance the adhesion to substrates, particularly plastic substrates.

Any suitable anti-oxidant(s) may be utilised, if deemed required. Examples may include: ethylene bis (oxyethylene) bis(3-tert-butyl-4-hydroxy-5(methylhydrocinnamate) 36443-68-2; tetrakis[methylene(3,5-di-tert-butyl-4-hydroxy hydrocinnamate)]methane 6683-19-8; octadecyl 3,5-di-tert-butyl-4-hydroxyhyrocinnamate 2082-79-3; N,N-hexamethylene-bis (3,5-di-tert-butyl-4-hydroxyhyrocinnamamide) 23128-74-7; 3,5-di-tert-butyl-4-hydroxyhydrocinnamic acid, C7-9 branched alkyl esters 125643-61-0; N-phenylbenzene amine, reaction products with 2,4,4-trimethylpentene 68411-46-1; e.g. anti-oxidants sold under the Irganox® name from BASF.

UV and/or light stabilizers may include, for the sake of example include benzotriazole, ultraviolet light absorbers and/or hindered amine light stabilizers (HALS) such as the TINUVIN® product line from Ciba Specialty Chemicals Inc.

Pigments are utilized to color the composition as required. Any suitable pigment may be utilized providing it is compatible with the composition. When present carbon black will function as both a non-reinforcing filler and colorant and is present in a range of from 1 to 30 wt. % of the composition, alternatively from 1 to 20 wt. % of the catalyst package composition; alternatively, from 5 to 20 wt. % of the composition, alternatively, from 7.5 to 20 wt. % of the composition.

Any suitable —OH (moisture/water/alcohol) scavenger may be used, for example orthoformic acid esters, molecular sieves, silazanes e.g. organosilazanes hexaalkyl disilazane, e.g. hexamethyldisilazane and/or one or more silanes of the structure

R²⁰ⱼSi(OR²¹)₄₋ⱼ

where each R²¹ may be the same or different and is an alkyl group containing at least 2 carbon atoms;
j is 1 or 0; and
R²⁰ is a silicon-bonded organic group selected from a substituted or unsubstituted straight or branched monovalent hydrocarbon group having at least 2 carbons, a cycloalkyl group, an aryl group, an aralkyl group or any one of the foregoing wherein at least one hydrogen atom bonded to carbon is substituted by a halogen atom, or an organic group having an epoxy group, a glycidyl group, an acyl group, a carboxyl group, an ester group, an amino group, an amide group, a (meth)acryl group, a mercapto group or an isocyanate group. When present the scavenger is typically introduced into the composition in an amount in a range of from 0.5 to 3.0 wt. % of the total wt. % composition, however the amount may be more, dependent on the amounts of alcoholic by-products being generated and the process being used to generate the composition. The scavenged by-products are intentionally removed, if possible, from the final sealant composition to attain stability and prevent pre-cure reversion during storage.

In one embodiment the polydiorganosiloxane elastomer composition comprises an —OH scavenger.

Plasticisers and/or Extenders (Sometimes Identified as Processing Aids)

Any suitable plasticiser or extender may be used if desired. These may be any of the plasticisers or extenders identified in GB2445821, incorporated herein by reference. When used the plasticiser or extender may be added before, after or during the preparation of the polymer, However, it does not contribute to or participate in the polymerisation process.

Examples of plasticisers or extenders include silicon containing liquids such as hexamethyldisiloxane, octamethyltrisiloxane, and other short chain linear siloxanes such as octamethyltrisiloxane, decamethyltetrasiloxane, dodecamethylpentasiloxane, tetradecamethylhexasiloxane, hexadeamethylheptasiloxane, heptamethyl-3-{(trimethylsilyl)oxy)}trisiloxane, cyclic siloxanes such as hexamethylcyclotrisiloxane, octamethylcyclotetrasiloxane, decamethylcyclopentasiloxane, dodecamethylcyclohexasiloxane; further polydiorganosiloxanes, optionally including aryl functional siloxanes, having a viscosity of from 0.5 to 12,500 mPa·s, measured at 25° C.; using Glass Capillary Viscometer (ASTM D-445, IP 71) for 0.5 to 5000 mPa·s (the 5000 mPa·s needs test at 100° C.). For 5000-12500 mPa·s, it will use Brookfield cone plate viscometer RV DIII with a cone plate CP-52 at 5 rpm (ASTM D4287).

Alternatively, the plasticisers or extenders may include organic liquids such as butyl acetate, alkanes, alcohols, ketones, esters, ethers, glycols, glycol ethers, hydrocarbons, hydrofluorocarbons or any other material which can dilute the composition without adversely affecting any of the component materials. Hydrocarbons include isododecane, isohexadecane, Isopar™ L (C11-C13), Isopar™ H (C11-C12), hydrogenated polydecene, mineral oil, especially hydrogenated mineral oil or white oil, liquid polyisobutene, isoparaffinic oil or petroleum jelly. Ethers and esters include isodecyl neopentanoate, neopentylglycol heptanoate, glycol distearate, dicaprylyl carbonate, diethylhexyl carbonate, propylene glycol n butyl ether, ethyl-3 ethoxypropionate, propylene glycol methyl ether acetate, tridecyl neopentanoate, propylene glycol methylether acetate (PGMEA), propylene glycol methylether (PGME), octyldodecyl neopentanoate, diisobutyl adipate, diisopropyl adipate, propylene glycol dicaprylate/dicaprate, and octyl palmitate. Additional organic diluents include fats, oils, fatty acids, and fatty alcohols. A mixture of diluents may also be used.

Biocides may additionally be utilized in the composition if required. It is intended that the term “biocides” includes bactericides, fungicides and algicides, and the like. Suitable examples of useful biocides, which may be utilized in compositions as described herein, include, for the sake of example:

Carbamates such as methyl-N-benzimidazol-2-ylcarbamate (carbendazim) and other suitable carbamates, 10,10′-oxybisphenoxarsine, 2-(4-thiazolyl)-benzimidazole, N-(fluorodichloromethylthio)phthalimide, diiodomethyl p-tolyl sulfone, if appropriate in combination with a UV stabilizer, such as 2,6-di(tert-butyl)-p-cresol, 3-iodo-2-propinyl butylcarbamate (IPBC), zinc 2-pyridinethiol 1-oxide, triazolyl compounds and isothiazolinones, such as 4,5-dichloro-2-(n-octyl)-4-isothiazolin-3-one (DCOIT), 2-(n-octyl)-4-isothiazolin-3-one (OIT) and n-butyl-1,2-benzisothiazolin-3-one (BBJT). Other biocides might include for example Zinc Pyridinethione, 1-(4-Chlorophenyl)-4,4-dimethyl-3-(1,2,4-triazol-1-ylmethyl)pentan-3-ol and/or 1-[[2-(2,4-dichlorophenyl)-4-propyl-1,3-dioxolan-2-yl] methyl]-1H-1,2,4-triazole.

The fungicide and/or biocide may suitably be present in an amount of from 0 to 0.3 wt. % of the polydiorganosiloxane elastomer composition and may be present in an encapsulated form where required such as described in EP2106418.

In general polymer (a) is prepared as described above, which is at least partially completed prior to addition of the other ingredients. Typically, the end-capping reaction is taken to completion before other ingredients of the polydiorganosiloxane elastomer composition are added. Furthermore, although unnecessary in the case of short-term storage, any neutralisation step and or end-capping catalyst removal step desired would typically be carried out prior to addition of the other ingredients of the polydiorganosiloxane elastomer composition.

As and when desired the alkoxy end-capped polymer from the or alkoxy end-capped, polydiorganosiloxane polymer reaction end-product may be used as ingredient (a) in the polydiorganosiloxane elastomer composition with the other ingredients introduced into the composition in any suitable order. As previously discussed all or some of the polyalkoxy silane excess from the end-capping reaction may be utilised as cross-linker (c) and as such further cross-linker (c) is optional, providing sufficient cross-linker (polyalkoxy silane excess) is available in the final polydiorganosiloxane elastomer composition for the composition to cure into an elastomeric product.

The first ingredient added to alkoxy end-capped, polydiorganosiloxane polymer reaction end-product (a) may for example be filler(s) (b) so as to effectively form a base comprising the alkoxy end-capped polydiorganosiloxane (a) and filler (b). The other ingredients may then be added in any preferred order of the addition such as additional cross-linker (c) if required, followed by condensation cure catalyst (d) followed by adhesion promoter (e) if required with the other optional additional ingredients added as and if required. Alternatively, the adhesion promoter when present, additional cross-linker, when required and catalyst may be added first followed by the filler(s) and finally an —OH (moisture/water/alcohol) scavenger to stabilize the composition e.g. during storage.

The process described herein is utilised to produce alkoxy end-capped polydiorganosiloxane polymers. The alkoxy end-capped polydiorganosiloxane polymers produced by the process described herein may be incorporated into polydiorganosiloxane elastomer compositions. The compositions are preferably room temperature vulcanisable compositions in that they cure at room temperature without heating but may if deemed appropriate be accelerated by heating.

The polydiorganosiloxane elastomer composition prepared from the alkoxy end-capped polydiorganosiloxane polymers produced by the process described herein may be designed to provide a low modulus and high extension sealant, adhesive and/or coating composition. Low modulus silicone sealant compositions are preferably “gunnable” i.e. they have a suitable extrusion capability i.e. a minimum extrusion rate of 10 ml/min as measured by ASTM C1183-04, alternatively 10 to 1000 mL/min, and alternatively 100 to 1000 mL/min.

The ingredients and their amounts in the polydiorganosiloxane elastomer composition may be selected to impart a movement capability to the post-cured sealant material. The movement capability is greater than 25%, alternatively movement capability ranges from 25% to 50%, as measured by ASTM C719-13.

A polydiorganosiloxane elastomer composition as hereinbefore described may be a gunnable sealant composition used for
(i) space/gap filling applications;
(ii) seal applications, such as sealing the edge of a lap joint in a construction membrane; or
(iii) seal penetration applications, e.g., sealing a vent in a construction membrane;
(iv) adhering at least two substrates together.
(v) a laminating layer between two substrates to produce a laminate of the first substrate, the sealant product and the second substrate.
   In the case of (v) above, when used as a layer in a laminate, the laminate structure produced is not limited to these three layers. Additional layers of cured sealant and substrate may be applied. The layer of gunnable polydiorganosiloxane elastomer composition as hereinbefore described in the laminate may be continuous or discontinuous.

A polydiorganosiloxane elastomer composition prepared from the alkoxy end-capped polydiorganosiloxane polymers produced by the process described herein may be applied on to any suitable substrate. Suitable substrates may include, but are not limited to, glass; concrete; brick; stucco; metals, such as aluminium, copper, gold, nickel, silicon, silver, stainless steel alloys, and titanium; ceramic materials; plastics including engineered plastics such as epoxies, polycarbonates, poly(butylene terephthalate) resins, polyamide resins and blends thereof, such as blends of polyamide resins with syndiotactic polystyrene such as those commercially available from The Dow Chemical Company, of Midland, Mich., U.S.A., acrylonitrile-butadiene-styrenes, styrene-modified poly(phenylene oxides), poly(phenylene sulfides), vinyl esters, polyphthalamides, and polyimides; cellulosic substrates such as paper, fabric, and wood; and combinations thereof. When more than one substrate is used, there is no requirement for the substrates to be made of the same material. For example, it is possible to form a laminate of plastic and metal substrates or wood and plastic substrates.

In the case of polydiorganosiloxane elastomer compositions prepared from the alkoxy end-capped polydiorganosiloxane polymers produced by the process described herein, the polydiorganosiloxane elastomer compositions may be used as silicone sealant compositions and there is provided a method for filling a space between two substrates so as to create a seal therebetween, comprising:
a) providing a polydiorganosiloxane elastomer composition as hereinbefore described, and either
b) applying the polydiorganosiloxane elastomer composition to a first substrate, and bringing a second substrate in contact with the polydiorganosiloxane elastomer composition that has been applied to the first substrate, or
c) filling a space formed by the arrangement of a first substrate and a second substrate with the polydiorganosiloxane elastomer composition and curing the polydiorganosiloxane elastomer composition.

In one alternative, polydiorganosiloxane elastomer composition prepared from the alkoxy end-capped polydiorganosiloxane polymers produced by the process described herein may be a self-levelling sealant composition, e.g. a self-levelling highway sealant. A self-levelling sealant composition means it is “self-levelling” when extruded from a storage container into a horizontal joint; that is, the sealant will flow under the force of gravity sufficiently to provide intimate contact between the sealant and the sides of the joint space. This allows maximum adhesion of the sealant to the joint surface to take place. The self-levelling also does away with the necessity of tooling the sealant after it is placed into the joint, such as is required with a sealant which is designed for use in both horizontal and vertical joints. Hence, the sealant flow sufficiently well to fill a crack upon application. If the sealant has sufficient flow, under the force of gravity, it will form an intimate contact with the sides of the irregular crack walls and form a good bond; without the necessity of tooling the sealant after it is extruded into the crack, in order to mechanically force it into contact with the crack sidewalls.

Self-levelling compositions as described herein are useful as a sealant having the unique combination of properties required to function in the sealing of asphalt pavement. Asphalt paving material is used to form asphalt highways by building up an appreciable thickness of material, such as 20.32 cm, and for rehabilitating deteriorating concrete highways by overlaying with a layer of a thickness such as 10.16 cm. Asphalt overlays undergo a phenomenon known as reflection cracking in which cracks form in the asphalt overlay due to the movement of the underlying concrete at the joints present in the concrete. These reflection cracks need to be sealed to prevent the intrusion of water into the crack, which will cause further destruction of the asphalt pavement when the water freezes and expands.

In order to form an effective seal for cracks that are subjected to movement for any reason, such as thermal expansion and contraction, the seal material must bond to the interface at the sidewall of the crack and must not fail cohesively when the crack compresses and expands. In the case of the asphalt pavement, the sealant must not exert enough strain on the asphalt at the interface to cause the asphalt itself to fail; that is, the modulus of the sealant must be low enough that the stress applied at the bond line is well below the yield strength of the asphalt.

In such instances, the modulus of the cured material is designed to be low enough so that it does not exert sufficient force on the asphalt to cause the asphalt to fail cohesively. The cured material is such that when it is put under tension, the level of stress caused by the tension decreases with time so that the joint is not subjected to high stress levels, even if the elongation is severe.

Alternatively, the polydiorganosiloxane elastomer composition prepared from the alkoxy end-capped polydiorganosiloxane polymers produced by the process described herein may be utilised as an elastomeric coating composition, e.g. as a barrier coating for construction materials or as a weatherproof coating for a roof, the composition may have a viscosity not dissimilar to a paint thereby enabling application by e.g. brush, roller or spray gun or the like. A coating composition as described herein, when applied onto a substrate, may be designed to provide the substrate with e.g. long-term protection from air and water infiltration, under normal movement situations caused by e.g. seasonal thermal expansion and/or contraction, ultra-violet light and the weather.

### EXAMPLES

Unless otherwise indicated, All viscosity measurements were undertaken using either a Brookfield® rotational viscometer with spindle LV-4 (designed for viscosities in the range between 1,000-2,000,000 mPa·s or a Brookfield® rotational viscometer with spindle LV-1 (designed for viscosities in the range between 15-20,000 mPa·s) for viscosities less than 1000 mPa·s and adapting the speed (shear rate) according to the polymer viscosity and measurements were taken at 25° C.

### Example 1

A Max100 speedmixer cup was charged with:
(i) 40 g of a dimethylsilanol terminated polydimethylsiloxane having a viscosity of 42 mPa·s and an average of 3.7 wt. % Si—OH groups per molecule; and
(ii) 47 g methyltrimethoxy silane.
   0.6 g of 1,8-diazabicyclo[5.4.0]undec-7-ene (DBU) was then added and the mixture was mixed for three periods of 20 seconds at 2000 rpm. The resulting mixture was then left at 23° C. for 18 hours.

After the 18-hour period the resulting product was complete providing give a reaction end-product of methyldimethoxy-terminated polydimethylsiloxane with >99.6% conversion as measured by ²⁹Si NMR and also ¹H NMR. Conversion was measured by observing the disappearance of silanol signal (²⁹Si NMR (80 MHz, CDCl₃) δ −12 and ¹H NMR (400 MHz, CDCl₃) δ 0.85) and corresponding appearance of methyldimethoxysilyl end-caps (²⁹Si NMR (80 MHz, CDCl₃) δ −48 and ¹H NMR (400 MHz, CDCl₃) δ 3.48).

### Comparative Example 1

A Max100 speedmixer cup was charged with
(i) 40 g of a dimethylsilanol terminated polydimethylsiloxane having a viscosity of 42 mPa·s and an average of 3.7 wt. % Si—OH groups per molecule and
(ii) 47 g methyltrimethoxy silane.

The resulting mixture was mixed for three periods of 20 seconds at 2000 rpm and then left at 23° C. for one week. The mixture was analyzed using ¹H and ²⁹Si NMR after the 1-week period and no evidence of any reaction having taken place was observed. The reaction end-product only contained unreacted starting materials.

### Example 2

A Max40 speedmixer cup was charged with:
(i) 10 g of a dimethylsilanol terminated polydimethylsiloxane having a viscosity of 42 mPa·s and an average of 3.7 wt. % Si—OH groups per molecule; and
(ii) 5.9 g methyltrimethoxy silane.
   0.05 g of DBU was then added and the mixture was mixed for three periods of 20 seconds at 2000 rpm. The resulting reaction mixture was then left at 23° C. The reaction mixture was analyzed at 2 and 24 hours by NMR using the polydimethylsiloxane backbone signal as an internal standard (¹H NMR (400 MHz, CDCl₃) δ 3.48, 0.06). By comparison of the relative amount of alkoxysilane end-capping groups compared to polydimethylsiloxane backbone, the reaction was determined to have proceeded with >99.6% conversion in 2 hours to give a methyldimethoxy-terminated polydimethylsiloxane product.

### Comparative Example 2

A Max100 speedmixer cup was charged with:
(i) 10 g of a dimethylsilanol terminated polydimethylsiloxane having a viscosity of 42 mPa·s and an average of 3.7 wt. % Si—OH groups per molecule; and
(ii) 5.9 g methyltrimethoxy silane.
   0.05 g of 2-ethylhexanoic acid (2-EHA) and 0.05 g of DBU was then added (i.e., using 2-EHA as catalyst and DBU as co-catalyst) and the mixture was mixed for three periods of 20 seconds at 2000 rpm. The reaction mixture was analyzed at 2 and 24 hours by NMR using the polydimethylsiloxane backbone signal as an internal standard (¹H NMR (400 MHz, CDCl₃) δ 3.48, 0.06). By comparison of the relative amount of alkoxysilane end-capping groups compared to polydimethylsiloxane backbone, the reaction was determined to have proceeded with 90% conversion in 2 hours to give methyldimethoxy-terminated polydimethylsiloxane product.

This is a lower conversion than measured in example 2.

### Comparative Example 3

A Max100 speedmixer cup was charged with:
(i) 10 g of a dimethylsilanol terminated polydimethylsiloxane having a viscosity of 42 mPa·s and an average of 3.7 wt. % Si—OH groups per molecule; and
(ii) 5.9 g methyltrimethoxy silane.
   0.017 g of barium oxide was then added and the mixture was mixed for three periods of 20 seconds at 2000 rpm. The resulting mixture was then left at 23° C. and analyzed by NMR at 2 and 24 hours using ¹H NMR (400 MHz, CDCl₃). The reaction showed approximately 21% conversion by NMR analysis to alkoxysilane-terminated product at 2 hours, however, by 24 hours, the reaction appeared cloudy and ¹H NMR revealed a complex mixture of unidentified products. Furthermore, while methyltrimethoxysilane was added in excess, no silane starting material was observed after 24 hours, suggesting further undesired reaction and decomposition.

### Example 3

A Max300 speedmixer cup was charged with:
(i) 250 g of a dimethylsilanol terminated polydimethylsiloxane having a viscosity of 56,000 mPa·s and an average of 0.05 wt. % Si—OH groups per molecule; and
(ii) 4.3 g methyltrimethoxy silane.
   The mixture was stirred and then 0.001 g 1,5,7-triazabicyclo[4.4.0]dec-5-ene (TBD) was added. The mixture was mixed for three periods of 20 seconds at 2000 rpm. The resulting mixture was then left at 23° C. for 18 hours. After the 18-hour period the reaction had completed providing give a reaction end-product of methyldimethoxy-terminated polydimethylsiloxane with >99.6% conversion as measured by ¹H NMR (400 MHz, CDCl₃).

### Comparative Example 4

A Max100 speedmixer cup was charged with:
(j) 10 g of a dimethylsilanol terminated polydimethylsiloxane having a viscosity of 42 mPa·s and an average of 3.7 wt. % Si—OH groups per molecule; and
(ii) 5.9 g methyltrimethoxy silane.
   0.36 g of a Pt solution (1.3 wt % platinum, 1,3-diethenyl-1,1,3,3-tetramethyldisiloxane complex in dimethylvinylsiloxy-terminated dimethyl siloxane) was then added, and the mixture was mixed for three periods of 20 seconds at 2000 rpm. The resulting mixture was then left at 23° C. and analyzed by NMR at 96 hours using ²⁹Si NMR (80 MHz, CDCl₃). The reaction showed approximately 0% conversion by NMR analysis to alkoxysilane-terminated product.

### Comparative Example 5

A Max100 speedmixer cup was charged with:
(j) 40 g of a dimethylsilanol terminated polydimethylsiloxane having a viscosity of 56,000 mPa·s and an average of 0.05 wt. % Si—OH groups per molecule; and
(ii) 0.69 g methyltrimethoxy silane.
   0.04 g of a 0.4 M lithium trimethylsilanolate solution in toluene was added. The mixture was mixed for three periods of 20 seconds at 2000 rpm. The resulting mixture was then left at 23° C. and analyzed by NMR at 24 hours using ²⁹Si NMR (80 MHz, CDCl₃). The reaction showed approximately 0% conversion by NMR analysis to alkoxysilane-terminated product.

### Example 4

A Max100 SpeedMixer cup was charged with:
(k) 40 g of a dimethylsilanol terminated polydimethylsiloxane having a viscosity of 56,000 mPa·s and an average of 0.05 wt. % Si—OH groups per molecule; and
(ii) 1.65 g 1,6-bis(trimethoxysilyl)hexane.
   The mixture was stirred and then 0.0002 g 1,5,7-triazabicyclo[4.4.0]dec-5-ene (TBD) was added. The mixture was mixed for three periods of 20 seconds at 2000 rpm. The resulting mixture was then left at 23° C. for 18 hours. After the 18 hour period the resulting product was complete providing give a reaction end-product of methyldimethoxy-terminated polydimethylsiloxane with >99.6% conversion as measured by ¹H NMR (400 MHz, CDCl₃) and ²⁹Si NMR (80 MHz, CDCl₃).

### Example 5

A Max100 SpeedMixer cup was charged with:
(1) 40 g of a dimethylsilanol terminated polydimethylsiloxane having a viscosity of 56,000 mPa·s and an average of 0.05 wt. % Si—OH groups per molecule; and
(ii) 0.79 g vinyltrimethoxysilane.
   The mixture was stirred and then 0.0002 g 1,5,7-triazabicyclo[4.4.0]dec-5-ene (TBD) was added. The mixture was mixed for three periods of 20 seconds at 2000 rpm. The resulting mixture was then left at 23° C. for 2 hours. After the 2 hour period the resulting product was complete providing give a reaction end-product of methyldimethoxy-terminated polydimethylsiloxane with >99.6% conversion as measured by ¹H NMR (400 MHz, CDCl₃) and ²⁹Si NMR (80 MHz, CDCl₃).

### Example 6

A Max300 SpeedMixer cup was charged with:
(m) 250 g of a dimethylsilanol terminated polydimethylsiloxane having a viscosity of 56,000 mPa·s and an average of 0.05 wt. % Si—OH groups per molecule; and
(ii) 4.3 g methyltrimethoxysilane.
   The mixture was mixed for three periods of 20 seconds at 2000 rpm. Initial viscosity was measured by ARES cone and plate rheometer. Then 0.0011 g 1,5,7-triazabicyclo[4.4.0]dec-5-ene (TBD) was added and the mixture was mixed for three periods of 20 seconds at 2000 rpm. The resulting mixture was then left at 23° C. Viscosity was measured using an ARES cone and plate rheometer cone and plate rheometer at different time points. and the resulting viscosity of the material is given below in Table 1.

TABLE 1

| Time (h) | 0 | 72 | 168 (7 days) | 336 (14 days) |
|---|---|---|---|---|
| Viscosity (mPa · s) | 46,389 | 47,338 | 45,205 | 41,239 |

As shown, this reaction mixture can be stored at room temperature for 168 h without change, and 336 h with slight degradation.

### Example 7

A Max300 SpeedMixer cup was charged with:
(n) 250 g of a dimethylsilanol terminated polydimethylsiloxane having a viscosity of 56,000 mPa·s and an average of 0.05 wt. % Si—OH groups per molecule; and
(ii) 4.3 g methyltrimethoxysilane.
   The mixture was mixed for three periods of 20 seconds at 2000 rpm. Initial viscosity was measured using an ARES cone and plate rheometer. Then 0.0110 g 1,5,7-triazabicyclo[4.4.0]dec-5-ene (TBD) was added and the mixture was mixed for three periods of 20 seconds at 2000 rpm. The resulting mixture was then left at 23° C. Viscosity was measured using an ARES cone and plate rheometer at different time points. Viscosity of the material is given below in Table 2.

TABLE 2

| Time (h) | 0 | 72 | 168 | 336 |
|---|---|---|---|---|
| Viscosity (mPa · s) | 46,316 | 41,052 | 24,130 | 7,771 |

As shown, the reaction mixture can be stored at room temperature for 72 h without degradation.

### Example 8

A Max300 SpeedMixer cup was charged with:
(i) 250 g of a dimethylsilanol terminated polydimethylsiloxane having a viscosity of 56,000 mPa·s and an average of 0.05 wt. % Si—OH groups per molecule; and
(ii) 4.3 g methyltrimethoxysilane.
   The mixture was mixed for three periods of 20 seconds at 2000 rpm. Initial viscosity was measured using an ARES cone and plate rheometer. Then 0.1100 g 1,5,7-triazabicyclo[4.4.0]dec-5-ene (TBD) was added and the mixture was mixed for three periods of 20 seconds at 2000 rpm. The resulting mixture was then left at 23° C. Viscosity was measured by an ARES cone and plate rheometer at different time points. Viscosity of the material is given below in Table 3.

TABLE 3

| Time (h) | 0 | 72 | 168 | 336 |
|---|---|---|---|---|
| Viscosity (mPa · s) | 48,737 | 5,245 | 1,041 | 550 |

As shown, the reaction mixture stored at room temperature for 72 h already shows significant degradation.

### Examples 9-15

In the following embodiments the end-capped polymer made in accordance with the current disclosure was prepared as a first step in the preparation of a sealant composition using a variety of silanes. In examples 9 to 15 a dimethylsilanol terminated polydimethylsiloxane having a viscosity of 56,000 mPa·s and an average of 0.05 wt. % Si—OH groups per molecule was mixed with an assortment of potential capping silanes and a catalyst. The catalyst used was a 2% solution of Triazabicyclodecene (TBD) in toluene. The mixture was stirred for 20 seconds @ 2000 rpm in a SpeedMixer and was then heated to a temperature of 50° C. maintained at that temperature to react for 60 minutes at which point the resulting mixture was sampled and analyzed by ¹H NMR to determine the reaction had gone to completion.

The compositions used are identified in Table 4 below.

TABLE 4
ingredients for End-capping process described herein

| | Ex. 9 | Ex. 10 | Ex. 11 | Ex. 12 | Ex. 13 | Ex. 14 | Ex. 15 |
|---|---|---|---|---|---|---|---|
| Polymer | 86.80 | 86.80 | 86.80 | 86.80 | 86.80 | 86.80 | 86.80 |
| Vinyltrimethoxy silane | 1.70 | 1.70 | 2.70 | 1.70 | 1.70 | | |
| methyltrimethoxysilane | 1.0 | 1.0 | | | | | |
| Isobutyltrimethoxy silane | | | | | 1.0 | | |
| Phenyltrimethoxysilane | | | | | | 2.0 | |
| 1,6- | | | | | | | 3.4 |
| bis(trimethoxysilyl)hexane | | | | | | | |
| Catalyst in toluene | 0.008 | 0.002 | 0.002 | 0.002 | 0.002 | 0.002 | 0.002 |

The polymer used in Table 1 was a dimethylsilanol terminated polydimethylsiloxane having a viscosity of 56,000 mPa·s at 25° C. and an average of 3.7 wt. % Si—OH groups per molecule. In this instance the catalyst was provided in a solution of toluene. It was later found to be optimum for the catalyst to be provided in a solution of another starting material, usually a polyalkoxy silane.

The alkoxy end-capped, polydiorganosiloxane polymer reaction end-product resulting from preparation as described herein and with respect to the Ex. 4-10 in Table 1 were each used to prepare a sealant formulation by taking the alkoxy end-capped, polydiorganosiloxane polymer reaction end-product and adding the ingredients indicated in Table 5 below:

TABLE 5
Ingredients for sealant formulation added
to the end-capped polymers made above.

| | Ex. 9 | Ex. 10 | Ex. 11 | Ex. 12 | Ex. 13 | Ex. 14 | Ex. 15 |
|---|---|---|---|---|---|---|---|
| AP | 1.10 | 1.10 | 1.10 | 1.10 | 1.10 | 1.10 | 1.10 |
| DBTDL | 0.16 | 0.16 | 0.16 | 0.16 | 0.16 | 0.16 | 0.16 |
| Filler | 8.0 | 8.0 | 8.0 | 8.0 | 8.0 | 8.0 | 8.0 |
| HMDZ | 2.5 | 2.5 | 2.5 | 2.5 | 2.5 | 2.5 | 2.5 |

In Table 5, DBTDL is the tin-based catalyst dibutyltin dilaurate; The adhesion promoter (AP) used was aminopropylaminoethyltrimethoxysilane. HMDZ is hexamethyldisilazane and is used as a scavenger; and the filler used was CAB-O-SIL LM-150 fumed silica from the Cabot Corporation

In the present series of examples, the sealant composition was prepared by initially adding adhesion promotor and tin catalyst into the alkoxy end-capped, polydiorganosiloxane polymer reaction end-product which contained polymer and an excess of polyalkoxysilane for use a cross-linker. These ingredients were then mixed together for 20 seconds at 2000 rpm in a SpeedMixer. The filler was then introduced into the mixture and the resulting composition was mixed for 40 seconds at 2000 rpm. Subsequently stabilizer (HMDZ) was added and the resulting mixture was again mixed for 20 seconds at 2000 rpm. The sealant composition was then stored for future use. The different compositions were tested for their physical properties and the results are depicted in Table 6 below.

TABLE 6
Physical Property results of sealant compositions
made in accordance with Table 5 above.

| | Ex. 9 | Ex. 10 | Ex. 11 | Ex. 12 | Ex. 13 | Ex. 14 | Ex. 15 |
|---|---|---|---|---|---|---|---|
| Rheo | good | good | good | good | good | good | flowable |
| SOT (min) | 15 | 15 | 10 | 5 | 20 | 15 | 20 |
| TFT (min) | 40 | 40 | 35 | 35 | 30 | 30 | 25 |
| 24 hour shelf | good | good | good | good | good | good | good |
| stability | | | | | | | |
| 1-day cure | good | good | good | good | good | good | good |

In Table 6 RHEO was a visual assessment as to whether the final product provided a non-sag or a flowable composition. The term good used in with respect to Rheo in Table 6 indicates that the composition was a non-sagging composition.

Skin over time (SOT) and tack free time (TFT) were measured in accordance with ASTM C679-15.

24 hour shelf stability was a visual test to determine whether or not the sealant composition gelled in the first 24 hours after the completion of the process. This can happen if the polymer end-capping process was not sufficiently complete before introduction of the tin-based catalyst. A stable material will be unchanged from the initial rheology, and specifically it will be un-gelled. A polymer used which is insufficiently capped prior to fully formulating in this tin chemistry will gel in the package in a short period. Good in this respect in Table 6 indicates the composition is un-gelled after 24 hours. The test sample was evaluated with a spatula for rheology.

24 hour cure evaluation was used to assess whether or not the cured elastomer has cured into a well-formed elastomer. This test involves to drawing down a 100 mil slab of sealant and allow to cure for 24 hours. The “cure evaluation” was peeling up the slab and pulling, while observing its mechanical properties. If the elastomeric product “peels up” and is elastic, it has passed the evaluation and was identified as “Good” in Table 6. A material which did not pass is still in a paste state and is therefore recorded as “uncured”.

1. A process for preparing an alkoxy end-capped polydiorganosiloxane from a silanol terminated polydiorganosiloxane starting material, the process comprising:
reacting the silanol terminated polydiorganosiloxane starting material with one or more polyalkoxy silane starting material(s) of the structure
(R²—O)_{(4-b)}—Si—R¹_{b}
where b is 0, 1 or 2, R² is an alkyl group having from 1 to 15 carbons and R¹ is a monovalent hydrocarbon radical, optionally R¹ is R² or is selected from cycloalkyl groups, alkenyl groups, aryl groups, aralkyl groups and groups obtained by replacing all or part of the hydrogen in the preceding organic groups with halogen;
in the presence of an end-capping catalyst starting material consisting of one or more linear, branched or cyclic molecules comprising at least one amidine group, guanidine group, or derivatives of the amidine group and/or guanidine group or a mixture thereof in an amount of from 0.0005 to 0.75 wt. % of the starting materials composition.

2. The process for preparing an alkoxy end-capped polydiorganosiloxane in accordance with claim 1, wherein the end-capping catalyst starting material comprises linear, branched or cyclic silicon containing molecules or linear, branched or cyclic organic molecules containing one or more of the groups (1) to (4) depicted below: 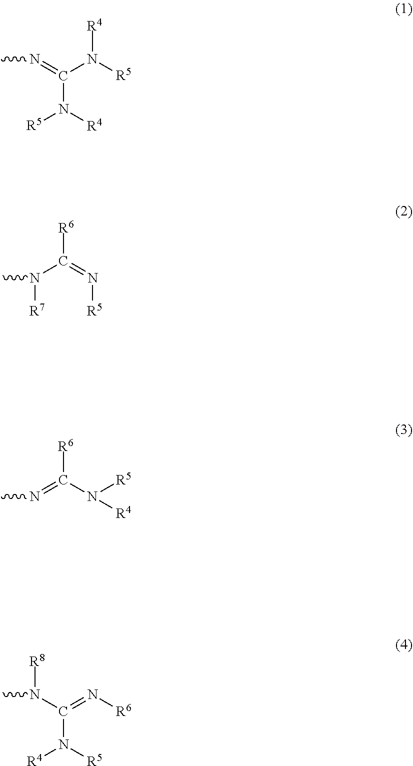
wherein each R⁴, R⁵, R⁶, R⁷ and R⁸ is the same or different and is selected from hydrogen, an alkyl group, a cycloalkyl group, a phenyl group, an aralkyl group or alternatively R⁴ and R⁵ or R⁶ and R⁵ or R⁷ and R⁵ or R⁸ and R⁴ may form optionally heterogeneously substituted alkylene group to form a ring structure, wherein the heterogeneous substitution is by means of an oxygen or nitrogen atom.

3. The process for preparing an alkoxy end-capped polydiorganosiloxane in accordance with claim 1, wherein the end-capping catalyst starting material comprises one or more of 1,1,3,3-tetramethylguanidine, 2-[3-(trimethoxysilyl)propyl]-1,1,3,3-tetramethylguanidine, 2-[3-(methyldimethoxysilyl)propyl]-1,1,3,3-tetramethylguanidine, Triazabicyclodecene (1,5,7-Triazabicyclo[4.4.0]dec-5-ene), 7-Methyl-1,5,7-triazabicyclo[4.4.0]dec-5-ene, 1,5-Diazabicyclo[4.3.0]non-5-ene, and 1,8-diazabicyclo[5.4.0]undec-7-ene.

4. The process for preparing an alkoxy end-capped polydiorganosiloxane in accordance with claim 1, wherein the process takes place in a static mixer.

5. The process for preparing an alkoxy end-capped polydiorganosiloxane in accordance with claim 1, wherein the alkoxy end-capped polydiorganosiloxane is not stabilized, neutralised or stabilized and neutralised upon completion of the process and/or does not have the end-capping catalyst starting material removed at the end of the process.

6. The process for preparing an alkoxy end-capped polydiorganosiloxane in accordance with claim 1, wherein the end-capping catalyst can be added directly as a solid or in solution in a compatible silicone or organic solvent or in one of the polyalkoxy silane starting materials being utilised to end-cap the silanol-terminated polydiorganosiloxane.

7. The process for preparing an alkoxy end-capped polydiorganosiloxane in accordance with claim 1, wherein the process takes place at a temperature of between 30 to 100° C.

8. The process for preparing an alkoxy end-capped polydiorganosiloxane in accordance with claim 1, wherein after completion of the process, the alkoxy end-capped polydiorganosiloxane final product is stored for a period of from 3 to 7 days prior to use.

9. The process for preparing an alkoxy end-capped polydiorganosiloxane in accordance with claim 1, wherein the polyalkoxy silane is provided in excess such that unreacted polyalkoxy silane is available to function as a cross-linker when utilised for making a sealant composition.

10. The process for preparing an alkoxy end-capped polydiorganosiloxane in accordance with claim 1, wherein alkoxy end-capped polydiorganosiloxane is subsequently used as an ingredient in a polydiorganosiloxane elastomer composition prepared by mixing the following ingredients:
(a) the alkoxy end-capped, polydiorganosiloxane polymer reaction end-product prepared in accordance with the preceding process;
(b) filler;
(d) a condensation cure catalyst; and
optionally
(c) cross-linker; and/or
(e) adhesion promoter.

11. An alkoxy end-capped, polydiorganosiloxane polymer obtainable or obtained from the process of claim 1.

12. A polydiorganosiloxane elastomer composition obtainable or obtained from the process of claim 10.

13. The polydiorganosiloxane elastomer composition in accordance with claim 12, wherein the polydiorganosiloxane elastomer composition additionally comprises an —OH scavenger.

14. The polydiorganosiloxane elastomer composition in accordance with claim 12, wherein the composition is a one-part composition and the condensation cure catalyst (d) is a tin-based catalyst.

15. A silicone elastomer obtained by curing the polydiorganosiloxane elastomer composition prepared in accordance with claim 12.

16. An alkoxy end-capped polydiorganosiloxane polymer prepared in accordance with the process of claim 1, present in a sealant in at least one of the facade, insulated glass, window construction, automotive, solar and construction fields.
